(19) United States
(12) Patent Application Publication
(10) Pub. No.: US 2015/0041590 A1
(43) Pub. Date: Feb. 12, 2015

(54) AIRFOIL WITH A TRAILING EDGE SUPPLEMENT STRUCTURE

(71) Applicant: General Electric Company, Schenectady, NY (US)

(72) Inventors: Kevin Richard Kirtley, Simpsonville, SC (US); David Edward Schick, Greenville, SC (US); Aaron Ezekiel Smith, Simpsonville, SC (US)

(73) Assignee: General Electric Company, Schenectady, NY (US)

(21) Appl. No.: 13/963,276

(22) Filed: Aug. 9, 2013

(51) Int. Cl. B64C 3/00

(52) U.S. Cl. CPC B64C 3/00
USPC 244/123.1; 60/805

(57) ABSTRACT

An airfoil includes a main portion formed of a base material and having an inner core comprising a hollow region. Also included is a trailing edge region of the main portion. Further included is a trailing edge supplement structure comprising a low-melt superalloy operatively coupled to the base material proximate the trailing edge region. Yet further included is at least one cooling passage fluidly coupling the inner core of the main portion to an inner region of the trailing edge region. Also included is a trailing edge region exhaust path disposed in the inner region and configured to route a cooling airflow in a span-wise direction of the airfoil.

### BACKGROUND OF THE INVENTION

The subject matter disclosed herein relates to airfoils, and more particularly to an airfoil with a trailing edge supplement structure.

Airfoils employed in various turbine systems are formed as buckets and nozzles. A working fluid such as hot gas or steam is typically forced across the airfoils, with the buckets coupled to a rotor of the turbine system. The force of the working fluid on the buckets causes the buckets, and therefore the coupled body of the rotor to rotate. As such, aerodynamic geometry of the airfoils impacts the overall system performance of the turbine system. Various manufacturing processes, such as casting, may be employed to form the airfoils, but such processes are limiting in certain respects, with one limitation relating to the aerodynamic characteristics of the manufactured airfoils.

The airfoils are typically formed of nickel, cobalt or iron-based superalloys with desirable mechanical and environmental properties for withstanding turbine operating temperatures and conditions. Because the efficiency of a turbine system is dependent on its operating temperatures, there is a demand for the airfoils to be capable of withstanding increasingly higher temperatures. As the local temperature of a superalloy component approaches the melting temperature of the superalloy, forced air cooling becomes necessary. For this reason, airfoils of gas turbine buckets and nozzles often require complex cooling schemes in which steam or air, typically bleed air, is forced through internal cooling passages within the airfoil and then discharged through cooling holes at the airfoil surface to transfer heat from the component. As noted above, the processes used to manufacture airfoils is somewhat limiting and this impacts the cooling passage precision, with respect to both location and dimension.

Typically, cooled airfoils use chord-wise holes through a thick trailing edge for cooling, pressure-side slots, or radial holes near the trailing edge through which a coolant passes. All three options are not ideal for cooling effectiveness or trailing edge thinness. The latter two options use a large amount of cooling air that offsets the aerodynamic benefit or are geometrically limited and cannot provide sufficient cooling air in the trailing edge region.

### BRIEF DESCRIPTION OF THE INVENTION

According to one aspect of the invention, an airfoil includes a main portion formed of a base material and having an inner core comprising a hollow region. Also included is a trailing edge region of the main portion. Further included is a trailing edge supplement structure comprising a low-melt superalloy operatively coupled to the base material proximate the trailing edge region. Yet further included is at least one cooling passage fluidly coupling the inner core of the main portion to an inner region of the trailing edge region. Also included is a trailing edge region exhaust path disposed in the inner region and configured to route a cooling airflow in a span-wise direction of the airfoil.

According to another aspect of the invention, an airfoil includes a main portion formed of a base material and having an inner core comprising a hollow region. Also included is a trailing edge region of the main portion. Further included is a trailing edge supplement structure comprising a first low-melt superalloy sheet and a second low-melt superalloy sheet, the first low-melt superalloy sheet and the second low-melt superalloy sheet operatively coupled to the base material of the main portion proximate the trailing edge. Yet further included is at least one cooling passage fluidly coupling the inner core of the main portion to an inner region of the trailing edge region. Also included is a trailing edge region exhaust path disposed in the inner region and configured to route a cooling airflow in a span-wise direction of the airfoil.

According to yet another aspect of the invention, a gas turbine engine includes a compressor, a combustor assembly, a turbine, and an airfoil disposed in at least one of the compressor and the turbine. The airfoil includes a main portion formed of a base material and having an inner core and a trailing edge region. The airfoil also includes a trailing edge supplement structure comprising a low-melt superalloy operatively coupled to the base material proximate the trailing edge region. The airfoil further includes at least one cooling passage fluidly coupling the inner core to an inner region of the trailing edge region. The airfoil yet further includes a trailing edge region exhaust path disposed in the inner region and configured to route a cooling airflow in a span-wise direction of the airfoil.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a top plan view of an airfoil;

FIG. 3 is an enlarged top plan view of section A of FIG. 2 illustrating a trailing edge region of the airfoil according to a first embodiment;

FIG. 4 is a cross-sectional view of a trailing edge supplement structure of the embodiment of FIG. 3 taken along line A-A of FIG. 2;

FIG. 5 is an enlarged top plan view of section A of FIG. 2 illustrating the trailing edge region of the airfoil according to a second embodiment;

FIG. 6 is a cross-sectional view of the trailing edge supplement structure of the embodiment of FIG. 5 taken along line A-A of FIG. 2;

FIG. 7 is an enlarged top plan view of section A of FIG. 2 illustrating the trailing edge region of the airfoil according to a third embodiment; and

FIG. 8 is a cross-sectional view of the trailing edge supplement structure of the embodiment of FIG. 7 taken along line A-A of FIG. 2.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system. The terms “chord-wise” and “span-wise” as used in this application refer to directions commonly associated with dimensions of the chord and span of an airfoil.

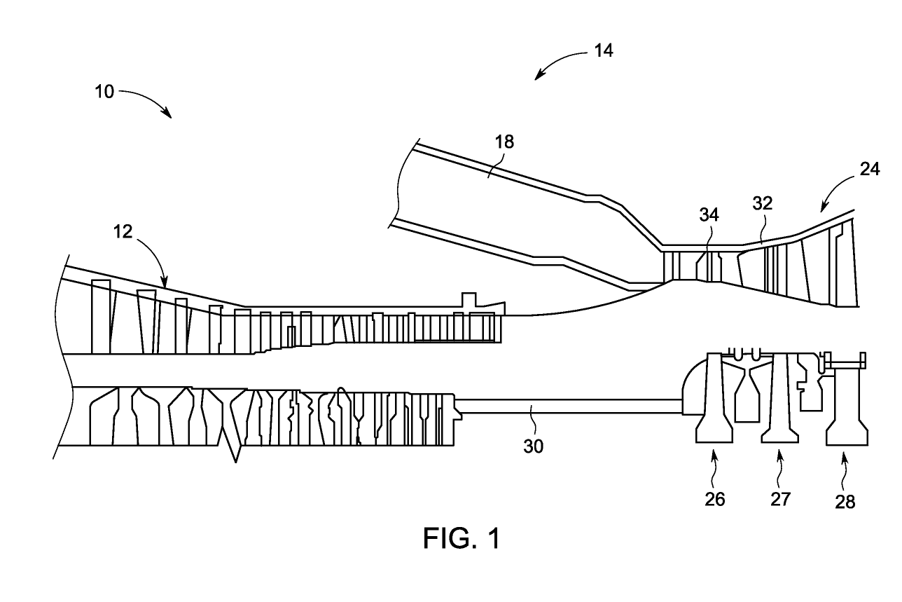

Referring to FIG. 1, a turbine system 10 constructed in accordance with an exemplary embodiment of the invention, is schematically illustrated. The turbine system 10 illustrated comprises a gas turbine engine, but it is to be appreciated that embodiments described herein may be employed in alternative systems, such as a steam turbine, for example. For purposes of illustration and discussion, the gas turbine engine is referenced.

The gas turbine engine 10 includes a compressor section 12 and a plurality of combustor assemblies arranged in a can annular array, one of which is indicated at 14 and includes a combustion section 18. It should be appreciated that this invention is independent of the details of the combustion system, and the can annular system is referenced for purposes of discussion. Fuel and compressed air are passed into the combustion section 18 and ignited to form a high temperature, high pressure combustion product or air stream that is used to drive a turbine section 24. The turbine section 24 includes a plurality of stages 26-28 that are operationally connected to the compressor section 12 through a rotor 30. In particular, each of the plurality of stages 26-28 includes a nozzle 32 and a bucket 34, with the bucket 34 operatively coupled to the rotor 30. The nozzle 32 and the bucket 34 of each of the plurality of stages 26-28 are airfoils that the working fluid (e.g., air-fuel mixture) passes over. Although three stages are identified, one can appreciate that more or less stages may be present.

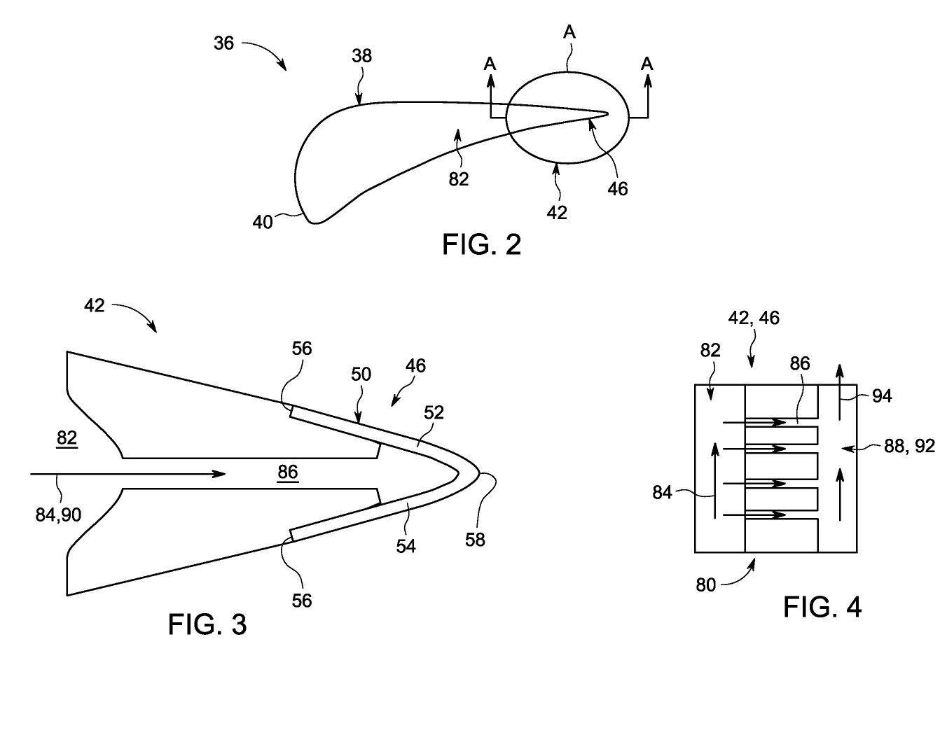

Referring now to FIG. 2, an airfoil 36 representing either the nozzle 32 or the bucket 34 is illustrated in greater detail. The airfoil 36 includes a main portion 38 that extends from a leading edge 40 to a trailing edge region 42. The main portion 38 is formed of a base material that may vary depending on the particular application. In some embodiments, the base material comprises a nickel-, cobalt-, or iron-based superalloy. The main portion 38 may be formed as an equiaxed, directionally solidified (DS), or single crystal (SX) casting to withstand the high temperatures and stresses to which it is subjected, such as within a gas turbine engine, for example. The trailing edge region 42 includes a trailing edge region aft width.

The airfoil 36 also includes a trailing edge supplement structure 46 that is operatively coupled to the main portion 38 proximate a surface of the trailing edge region 42. As shown, relative to the main portion 38, the trailing edge supplement structure 46 tapers to a thinner, more acute end portion, the dimension referred to herein as a trailing edge supplement structure aft width.

Referring to FIGS. 3 and 4, the trailing edge region 42 of the main portion 38 and the trailing edge supplement structure 46 according to a first embodiment are illustrated in greater detail. In the illustrated embodiment, the trailing edge supplement structure 46 includes a low-melt superalloy material comprising a blend of a superalloy base and a low melting braze alloy powder, referred to herein as a low-melt superalloy (LMS) sheet 50. An exemplary embodiment of the LMS sheet 50 is a first pre-sintered preform (PSP) structure. The LMS sheet 50 comprises a mixture of particles comprising a first alloy and a second alloy that have been sintered together at a temperature below their melting points to form an agglomerate and somewhat porous mass. Suitable particle size ranges for the powder particles include 150 mesh, or even 325 mesh or smaller to promote rapid sintering of the particles and reduce porosity in the LMS sheet 50 to about 10 volume percent or less.

The first alloy of the LMS sheet 50 comprises any composition such as one similar to the base material of the main portion 38 to promote common physical properties between the LMS sheet 50 and the main portion 38. For example, in some embodiments, the first alloy and the base material share a common composition (i.e., they are the same type of material). In some embodiments, the first alloy comprises a nickel-based superalloy or a cobalt-based superalloy. In some embodiments, the properties for the first alloy include chemical and metallurgical compatibility with the base material, such as high fatigue strength, low tendency for cracking, oxidation resistance and/or machinability.

The second alloy may also have a composition similar to the base material of the main portion 38, but further contains a melting point depressant to promote sintering of the first alloy and the second alloy particles and enable bonding of the LMS sheet 50 to the trailing edge region 42 of the main portion 38 at temperatures below the melting point of the base material. For example, in some embodiments the melting point depressant comprises boron, gold, copper, phosphorous, and/or silicon.

The LMS sheet 50 comprises any relative amounts of the first alloy and the second alloy that are sufficient to provide enough melting point depressant to ensure wetting and bonding (e.g., diffusion/brazing bonding) of the particles of the first alloy and the second alloy to each other and to the trailing edge region 42 of the main portion 38 of the airfoil 36. For example, in some embodiments the second alloy comprises at least about 10 weight percent of the LMS sheet 50. In one embodiment, the second alloy comprises about 70 weight percent of the LMS sheet 50, with the first alloy comprising about 30 weight percent of the LMS sheet 50, thereby resulting in a mixed weight ratio of the first alloy to the second alloy of about 30:70. In another embodiment, a mixed weight ratio of the first alloy to the second alloy of about 40:60 is employed.

In the illustrated embodiment, the trailing edge supplement structure 46 a single component having a first portion 52 and a second portion 54 integrally formed with each other. The first portion 52 and the second portion 54 each include an upstream end 56 bonded to the trailing edge region 42 of the main portion 38. The first portion 52 and the second portion 54 also each include a downstream end 58 that intersect with each other to form an acute apex of the airfoil 36. The narrow, acute angle of the downstream end 58 of the trailing edge supplement structure 46 enables a thinner trailing edge portion of the airfoil 36, which effectively reduces aerodynamic blockage, thereby improving overall turbine system performance.

The above-described embodiments of the trailing edge supplement structure 46 are illustrated and described as having a single LMS sheet. However, it is to be understood that a plurality of LMS sheets may be employed and operatively coupled to the trailing edge region 42 of the main portion 38.

Irrespective of the precise number of LMS sheets employed, the sheet(s) are operatively coupled to the trailing edge region 42 of the main portion 38. In one embodiment, the LMS sheets are brazed to the trailing edge region 42. The LMS sheets are formed of materials configured to be brazed to the trailing edge region 42 without the need for application of a braze paste. In this way, the LMS sheet(s) are positioned in a desirable location in an abutting manner with the trailing edge region 42 within a furnace and heated to a necessary temperature to facilitate brazing of the LMS sheets to the main portion 38. In addition to brazing, it is contemplated that alternative coupling techniques may be employed, including, but not limited to, welding, diffusion bonding or mechanical fastening.

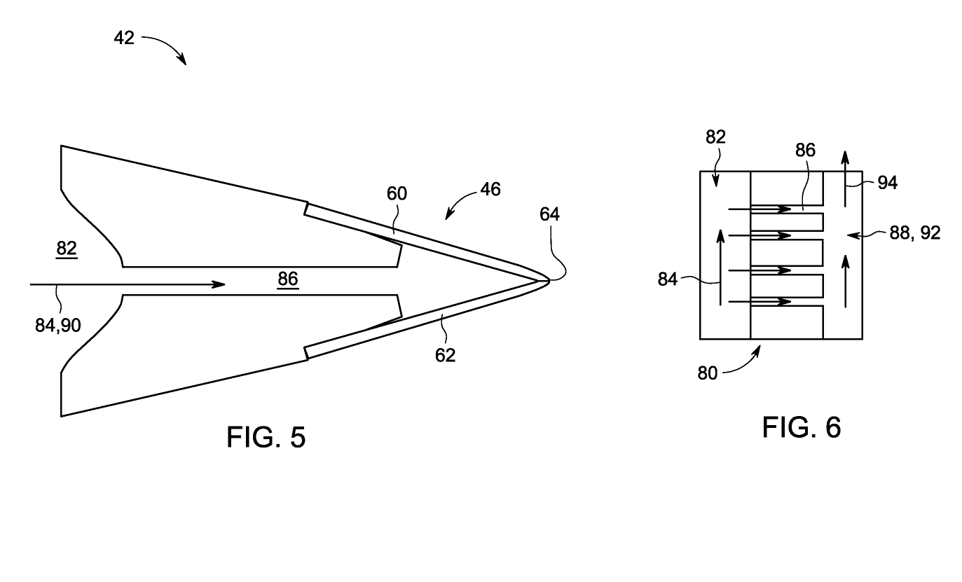

Referring to FIGS. 2, 5 and 6, the trailing edge region 42 of the main portion 38 and the trailing edge supplement structure 46 according to a second embodiment are illustrated in detail. The trailing edge supplement structure 46 comprises similar materials and bonding processes as those discussed herein in significant detail, such that similar reference numerals are employed where appropriate and duplicative description is omitted. In the illustrated embodiment, the trailing edge supplement structure 46 comprises a first LMS sheet 60 and a second LMS sheet 62 operatively coupled to the base material of the main portion 38 proximate the trailing edge region 42. The first LMS sheet 60 and the second LMS sheet 62 each comprise a downstream end 64 intersecting each other to form an acute apex of the airfoil 36.

Referring to FIGS. 2, 7 and 8, the trailing edge region 42 of the main portion 38 and the trailing edge supplement structure 46 according to a third embodiment are illustrated in detail. The trailing edge supplement structure 46 comprises similar materials and bonding processes as those discussed herein, with respect to the embodiments described above, such that similar reference numerals are employed where appropriate and duplicative description is omitted.

In the illustrated embodiment, a single LMS structure or sheet is employed, such as the first LMS sheet 50 described above in conjunction with the first embodiment. As shown, the first LMS sheet 50 is bonded at multiple locations to the trailing edge region 42 of the main portion 38 of the airfoil 36. In particular, the first LMS sheet 50 is bonded at the upstream end 56 and the downstream end 58 to the trailing edge region 42, with the downstream end 58 of the first LMS sheet 50 bonded to a downstream point 70 of the trailing edge region 42. Additional bonding intersections may be present, as illustrated, and will be discussed in detail below.

Referring now to FIGS. 2-8, to provide effective cooling of the airfoil 36, a cooling arrangement 80 is implemented within the trailing edge region 42 of the main portion 38 and throughout the trailing edge supplement structure 46. The main portion 38 includes an inner core 82 comprising a hollow region. The inner core 82 is actively cooled with the provision of a cooling airflow 84 that is supplied from a cooling airflow source (not illustrated). The cooling airflow 84 is provided to cool the main portion 38 of the airfoil 36. The cooling arrangement 80 includes at least one, but typically a plurality of cooling passages 86 disposed in the trailing edge supplement structure 46. The plurality of cooling passages 86 fluidly couple the inner core 82 with an inner region 88 defined by one or more inner surfaces 89 of the trailing edge supplement structure 46 and is configured to route the cooling airflow 84 in a chord-wise direction 90 of the airfoil 36. The inner core 82 includes a trailing edge region exhaust path 92 configured to route the cooling airflow 84 in a span-wise direction 94 of the airfoil 36. In another embodiment, the trailing edge region exhaust path 92 is configured to route the cooling airflow 84 in the chord-wise direction 90 of the airfoil 36. In yet another embodiment, the trailing edge region exhaust path 92 is configured to route the cooling airflow 84 in a combination of the chord-wise direction 90 and the span-wise direction 94.

The plurality of cooling passages 86 may be formed in a variety of manners and at a variety of times throughout the manufacturing process. Specifically, the plurality of cooling passages 86 may be formed prior to coupling of the trailing edge supplement structure 46 to the main portion 38 or subsequent to coupling.

Formation of the plurality of cooling passages 86 prior to coupling of the trailing edge supplement structure 46 to the main portion 38 may include formation of negative grooves, slots or the like into the LMS sheet(s) during formation of the LSM sheet(s) themselves, such that the LMS sheets are still in their pliable “green state” before final sintering. Alternatively, the plurality of cooling passages 86 may be machined (i.e., removal of some material from the LMS sheet(s)) via any suitable material removal operation, including, but not limited to, milling, grinding, wire electrical discharge machining (EDM), milled EDM, plunge EDM, electro-chemical machining (ECM), waterjet trenching, laser trenching, or combinations thereof. Alternatively, or in combination with the above-described embodiments, the plurality of cooling passages 86 may be operatively coupled to, or integrally formed with, the inner region 88 or the main portion 38.

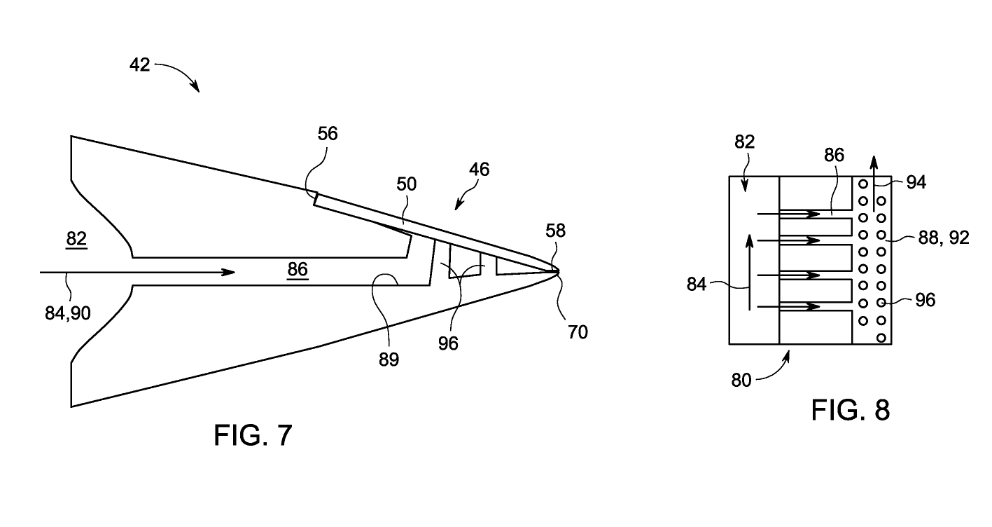

In one embodiment, at least one, but typically a plurality of cooling features 96 is disposed proximate the inner region 88 of the trailing edge region 42. The plurality of cooling features 96 may facilitate formation of the plurality of cooling passages 86 and may provide heat sinks to further cool the trailing edge region 42. As best shown in FIGS. 7 and 8, the plurality of cooling features 96 may be in the form of pins, turbulators, chevrons or other flow manipulating components. As with the general formation of the plurality of cooling passages 86, the plurality of cooling features 96 may be operatively coupled to, or integrally formed with, the one or more inner surfaces 89 of the trailing edge region 42. In an embodiment having integrally formed cooling features, a casting or machining process may be employed to form the cooling features in the trailing edge region 42.

In an embodiment employing a machine removal process to form the plurality of cooling passages 86 and/or the plurality of cooling features 96, it is contemplated that the material removal process may occur prior to coupling of the trailing edge supplement structure 46 to the main portion 38 or after such coupling. Regardless of the time of formation of the plurality of cooling passages 86 and/or the plurality of cooling features 96, the cooling passages and/or the cooling features are in fluid communication with the inner core 82. It is contemplated that the above-described embodiments may be incorporated into new or existing airfoils of various turbine systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An airfoil comprising:
a main portion formed of a base material and having an inner core comprising a hollow region;
a trailing edge region of the main portion;
a trailing edge supplement structure comprising a low-melt superalloy operatively coupled to the base material proximate the trailing edge region;
at least one cooling passage fluidly coupling the inner core of the main portion to an inner region of the trailing edge region; and
a trailing edge region exhaust path disposed in the inner region and configured to route a cooling airflow in a span-wise direction of the airfoil.

2. The airfoil of claim 1, wherein the trailing edge supplement structure is brazed to the trailing edge region.

3. The airfoil of claim 1, wherein the at least one cooling passage routes the cooling airflow in a chord-wise direction of the airfoil.

4. The airfoil of claim 1, wherein the low-melt superalloy comprises a pre-sintered preform (PSP) material.

5. The airfoil of claim 1, wherein the trailing edge supplement structure comprises a first portion and a second portion integrally formed with each other, the first portion and the second portion each having an upstream end bonded to the trailing edge region of the main portion.

6. The airfoil of claim 5, wherein the first portion and the second portion each comprise a downstream end intersecting each other to form an acute apex of the airfoil.

7. The airfoil of claim 1, further comprising at least one cooling feature disposed in the inner region of the trailing edge region.

8. The airfoil of claim 7, wherein the at least one cooling feature comprises at least one pin.

9. The airfoil of claim 7, wherein the at least one cooling feature is operatively coupled to an inner surface of the inner region.

10. The airfoil of claim 7, wherein the at least one cooling feature is integrally formed in an inner surface of the inner region.

11. The airfoil of claim 10, wherein the at least one cooling feature is cast in the inner surface.

12. The airfoil of claim 10, wherein the at least one cooling feature is machined in the inner surface.

13. The airfoil of claim 7, wherein the trailing edge supplement structure comprises a single component having a downstream end bonded to a downstream point of the trailing edge region of the main portion.

14. The airfoil of claim 13, wherein the trailing edge supplement structure is bonded to the at least one cooling feature.

15. An airfoil comprising:
a main portion formed of a base material and having an inner core comprising a hollow region;
a trailing edge region of the main portion;
a trailing edge supplement structure comprising a first low-melt superalloy sheet and a second low-melt superalloy sheet, the first low-melt superalloy sheet and the second low-melt superalloy sheet operatively coupled to the base material of the main portion proximate the trailing edge region;
at least one cooling passage fluidly coupling the inner core of the main portion to an inner region of the trailing edge region; and
a trailing edge region exhaust path disposed in the inner region and configured to route a cooling airflow in at least one of a substantially span-wise and a substantially chord-wise direction of the airfoil.

16. The airfoil of claim 15, wherein the first low-melt superalloy sheet and the second low-melt superalloy sheet each comprise a downstream end intersecting each other to form an acute apex of the airfoil.

17. The airfoil of claim 15, wherein the trailing edge supplement structure is brazed to the trailing edge region.

18. The airfoil of claim 15, wherein the first low-melt superalloy sheet and the second low-melt superalloy sheet comprises a pre-sintered preform (PSP) material.

19. The airfoil of claim 15, further comprising at least one cooling feature integrally formed in the inner region of the trailing edge region.

20. A gas turbine engine comprising:
a compressor;
a combustor assembly;
a turbine; and
an airfoil disposed in at least one of the compressor and the turbine, the airfoil comprising:
a main portion formed of a base material and having an inner core and a trailing edge region;
a trailing edge supplement structure comprising a low-melt superalloy operatively coupled to the base material proximate the trailing edge region;
at least one cooling passage fluidly coupling the inner core to an inner region of the trailing edge region; and
a trailing edge region exhaust path disposed in the inner region and configured to route a cooling airflow in a span-wise direction of the airfoil.
